(19) United States
(12) Patent Application Publication
(10) Pub. No.: US 2015/0036892 A1
(43) Pub. Date: Feb. 5, 2015

(54) TRAVEL CHECK-IN METHOD

(71) Applicant: NCR CORPORATION, Duluth, GA (US)

(72) Inventor: Jared Keith Miller, Cumming, GA (US)

(73) Assignee: NCR CORPORATION, Duluth, GA (US)

(21) Appl. No.: 13/954,495

(22) Filed: Jul. 30, 2013

(51) Int. Cl. G06Q 10/02; G06K 9/00; G07C 9/00

(52) U.S. Cl. CPC G06Q 10/02; G07C 9/00031; G06K 9/00442
USPC 382/115

(57) ABSTRACT

A travel check-in method with improved travel document information capture and handling. An example method includes connecting to a travel check-in website by the computer, operating an image capture device by the computer to capture an image of an identification document of a passenger checking in, obtaining machine readable information from the image by the computer, and sending the machine readable information and the image to the travel check-in website by the computer. The method may be in lieu of the passenger providing the identification document to an agent at an airport or other departure point.

### Background

The present invention relates to travel systems, and more specifically to a travel check-in method.

International flight check-in typically requires the collection and transmission of details of passports, visas, or other required travel documents. Air carriers are subject to significant fines and other consequences in the event a passenger travels with improper travel documentation or improperly transmitted travel document information. The information transmitted typically includes details such as name, nationality, document number, document expiration, and issuing authority.

Many air carriers today offer remote flight check-in to personal computer and mobile device users through World Wide Web (web) sites, accessed using browser software, and mobile applications. Passengers manually enter international travel document information. At the airport, passengers must wait to have their travel document information verified and re-entered to ensure accuracy. This degrades the passenger experience and decreases employee productivity.

Therefore, it would be desirable to provide a travel check-in method with improved travel document information capture and handling.

### SUMMARY

In accordance with the teachings of the present invention, a travel check-in method is provided.

An example method includes operating an image capture device by a computer to capture an image of an identification document, determining information from the image by the computer, and sending the information to a website that requests the information by the computer.

Another example method includes connecting to a travel check-in website by the computer, operating an image capture device by the computer to capture an image of an identification document of a passenger checking in, obtaining machine readable information from the image by the computer, and sending the machine readable information and the image to the travel check-in website by the computer.

Another example method includes hosting a travel check-in website, prompting a passenger to operate an image capture device to capture an image of an identification document of the passenger during check-in at the travel check-in website, receiving machine readable information from the image, and storing the machine readable information in a passenger record.

Any of the example methods may further include providing an indication to an agent that a passenger has sent the machine readable information to the travel check-in website in lieu of providing the travel document to the agent.

### BRIEF DESCRIPTION OF THE DRAWINGS

FIG. 1 is a block diagram of an example travel system.

FIGS. 2A-2B form a flow diagram illustrating an example self check-in method.

### DETAILED DESCRIPTION

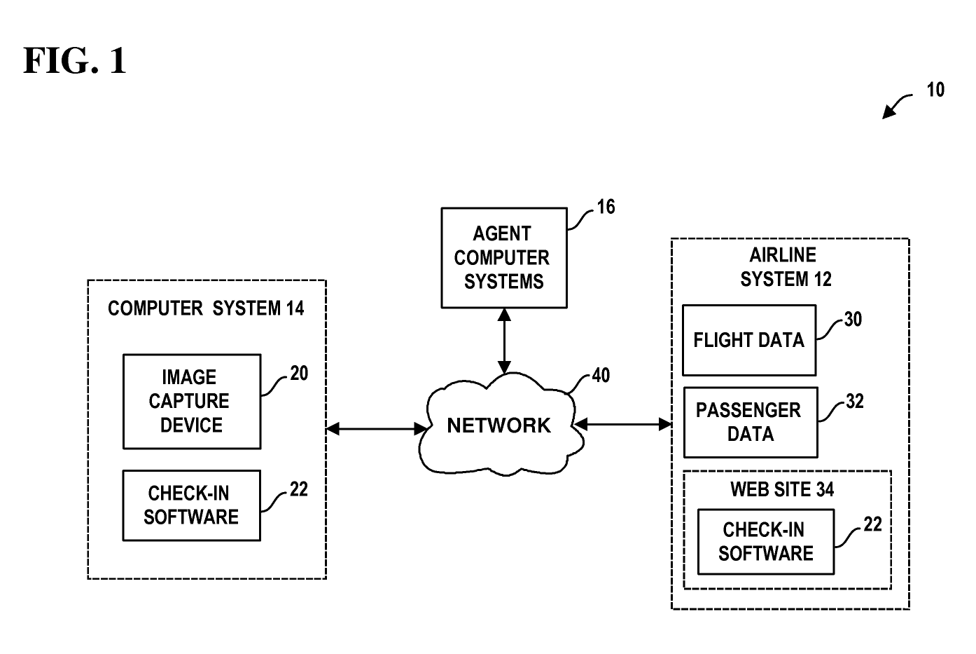

Turning now to FIG. 1, travel system 10 is illustrated in an air travel example. Other types of transportation methods and corresponding types of travel systems are also envisioned.

Example travel system 10 primarily includes one or more airline systems 12. Airline system 12 includes one or more servers including one or more processors, memory, and program and data storage. Airline system 12 may execute an operating system such as a Microsoft or Linux operating system. Airline system 12 further includes network circuitry for connecting to network 40, and may include other circuitry for connecting to peripherals, such as a display, a printer, a mouse, and a keyboard.

Network 40 may include any combination of wireless or wired networks, including local area, wide area, virtual private, and global communication networks, such as the Internet.

Airline system 12 maintains one or more databases containing flight data 30 and passenger data 32. Flight data 30 may include information about each scheduled flight. Passenger data 32 may include passenger identification information and other information associated with the passenger identification information, including travel document information. Travel documents may include passports or visas issued by government authorities, or other required travel documents. Travel document information may include passenger nationality, travel document number, travel document expiration, travel document issuing authority, or other required information. Airline system 12 may also include third part host computers that store and manage some of the flight data 30 and passenger data 32 in a Departure Control System (DCS) for an airline.

Airline system 12 may be connected to the web and include a web server which hosts a web site 34 including web pages, web applications and other web content. Passengers may visit web site 34 to make or change reservations and to check-in for flights. For check-in, web site 34 may include or provide check-in software 22.

Passengers use computer system 14 to check-in. Computer system 14 may include a personal computer, kiosk, or mobile communication device.

A personal computer may include a desktop or laptop computer. The personal computer would typically be remote from an airport, but could be anywhere, so long as the personal computer has access to an image capture device 20. For example, a personal computer may be located at a traveler's home, at a hotel where the traveler is staying, or other location.

A kiosk may be located at an airport or may be located remotely from the airport, such as at a hotel.

A mobile communication device may include a smart phone, personal digital assistant, tablet computing device, or other portable communication device.

Computer system 14 may include one or more processors, memory, and program and data storage. Computer system 14 may execute an operating system such as a Microsoft, Google, or Apple operating system. Computer system 14 may execute other computer software, which may be stored in a computer readable medium, and which may include web browser software to display web pages from airline system 12 and check-in software 22. Computer system 14 further includes wired and/or wireless network circuitry for connecting to airline system 12 through network 40, and includes other circuitry for connecting to peripherals, such as image capture device 20. Computer system 14 includes other peripherals, such as a touch screen or a display, keyboard, and mouse.

Image capture device 20 may include a camera or scanner. For example, image capture device 20 may include a camera in a smart phone or tablet.

As another example, image capture device 20 may include a webcam in a laptop computer.

As another example, image capture device 20 may include a document and/or photo scanner of a desktop computer system.

As another example, image capture device 20 may include a travel document reader or a document and/or photo scanner of a kiosk at a hotel.

In any of the example computer system configurations above, check-in software 22 receives identifying information from the passenger and verifies the identifying information against passenger data 32 and/or flight data 30. Example identifying information may include a confirmation number, a name, and/or a flight number. If the verification passes, check-in software 22 prompts the passenger to capture travel document information from travel documents, such as passports and visas, and operates image capture device 22 under passenger control to capture the travel document information.

Check-in software 22 uses optical character recognition to recognize alphanumeric characters in captured images and convert them to text. Alphanumeric characters may be located in predetermined areas of the captured images referred to as Machine Readable Zones (MRZs). Check-in software 22 parses the captured images to identify the MRZs and parse the travel document information according to an international standard around the formatting of travel document information. Check-in software 22 may display the captured travel document information for the passenger to review for accuracy or allow another image to be captured in the event the first image was not clear.

Check-in software 22 sends one or both of the captured images and text to airline system 12, where the captured images and/or text are stored in a passenger record in passenger data 32. Storage of captured images may serve as evidence of authenticity of travel document information. Airline system 12 may then store an indication in the passenger's record that the captured travel document information is to be treated as “trusted” data, thereby eliminating the need in most cases to disrupt the customer experience by requiring the customer to either enter the document details again upon arrival to the airport or to see a gate agent prior to boarding an international flight. As used herein, “trusted” data is defined as travel document information either collected by an airline representative or captured through optical character recognition. Another way of saying this is that “untrusted” data is that data which is manually input by a customer, regardless of input channel.

Airline system 12 may make the travel document information in the passenger record available to a security agency, such as the Transportation Security Administration (TSA), for a security threat screening. Airline system 12 may use or otherwise make captured images and travel document information available for other purposes and/or transactions. For example, airline system 12 may use the captured images and travel document information in photo identification and age verification during purchases of alcohol by passengers.

Check-in software 22 may be written in a programming language such as the Java programming and be hosted within browser software.

As another example, check-in software 22 may include a script, written in a scripting language such as JavaScript, combined with hypertext markup language (HTML) or other suitable web page language and hosted within browser software.

As yet another example, check-in software 22 may include a software applet written to be executed within an operating system of a host computer system.

In all of these example embodiments of check-in software 22, the travel document information capture function of check-in software 22 may be included during development of check-in software 22 or be implemented as a software module that may be integrated into existing check-in software 22.

Example travel system 10 further includes agent computer systems 16 at terminal check-in and/or gate locations. In addition to other check-in functions, agent computer systems 16 may assist agents in making decisions regarding which passengers require their travel documents to be reviewed. Agents may be trained to only seek out passengers whose records do not contain trusted travel document information. For example, agent computer systems 16 may automatically search passenger records and display only names of passengers whose travel document information has not been received or marked as trusted.

Agent computer systems 16 each include one or more processors, memory, and program and data storage. Agent computer systems 16 may execute an operating system such as a Microsoft or Linux operating system. Agent computer systems 16 further include network circuitry for connecting to network 40, and may include other circuitry for connecting to peripherals, such as a touch screen or display, keyboard, and mouse.

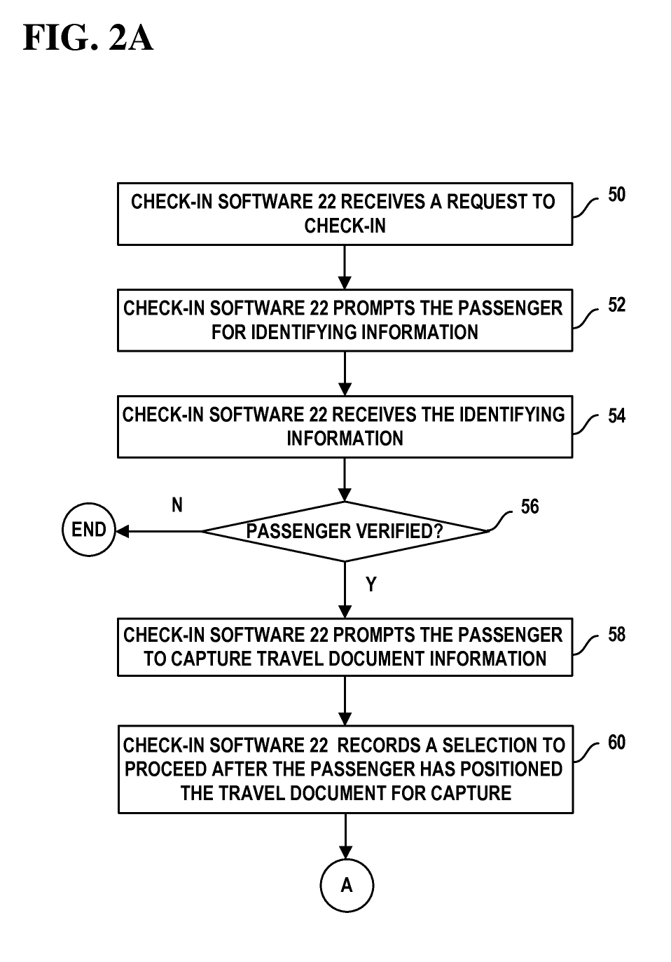

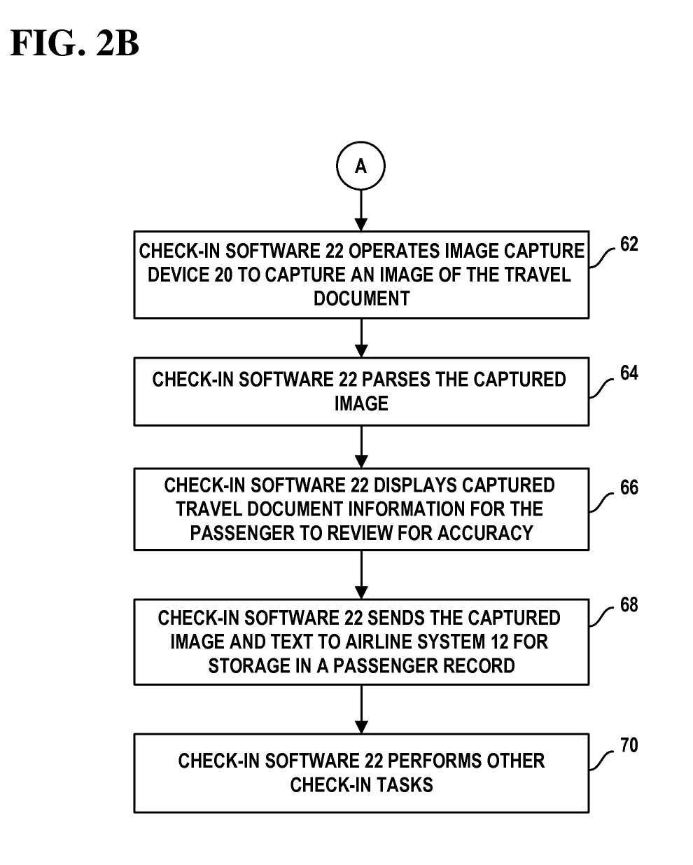

With reference to FIGS. 2A-2B, an example self check-in method is illustrated beginning with step 50. The example method streamlines the passenger experience by avoiding having to wait for verification and/or re-entry of the travel document information at the airport.

In step 50, check-in software 22 records a request to check-in from a passenger connected to web site 34 through network 40.

In step 52, check-in software 22 prompts the passenger for identifying information. Example identifying information may include a confirmation number, a name, and/or a flight number.

In step 54, check-in software 22 records identifying information from the passenger.

In step 56, check-in software 22 sends the identifying information to airline systems 12 to verify against passenger data 32 and/or flight data 30. If the verification passes, operation proceeds to step 58. Otherwise, operation ends. Check-in software 22 may display an error message indicating that the passenger and/or the flight cannot be found.

In step 58, check-in software 22 prompts the passenger to capture travel document information from a travel document, such as a passport, visa, or other required travel document.

In step 60, check-in software 22 records a selection to proceed after the passenger has positioned the travel document for capture.

In step 62, check-in software 22 operates image capture device 22 to capture an image of the travel document.

In step 64, check-in software 22 parses the captured image to identify the MRZ and obtain the travel document information.

In step 66, check-in software 22 displays captured travel document information for the passenger to review for accuracy. Operation returns to step 58 to capture another image if the captured image is not clear or the information is not accurate.

In step 68, check-in software 22 sends the captured image and text to airline system 12 for storage in a passenger record in passenger data 32.

In step 70, check-in software 22 performs other check-in tasks, such as baggage check-in, seat selection, meal selection, and provides a boarding pass, in digital form for storage and/or printing. Operation ends.

Upon arrival at the airport, the passenger proceeds to the gate without having to either enter the travel document details again or present the travel document to a gate or other agent prior to boarding an international flight. Using agent computer systems 16, agents only seek out passengers whose records do not contain trusted travel document information.

Although the present invention has been described with particular reference to certain preferred embodiments thereof, variations and modifications of the present invention can be effected within the spirit and scope of the following claims.

What is claimed is:

1. A processor-implemented method programmed in a non-transitory processor-readable medium and to execute on one or more processors of a computer configured to execute the method, comprising:
operating an image capture device by a computer to capture an image of an identification document;
determining information from the image by the computer; and
sending the information to a website that requests the information by the computer.

2. The method of claim 1, further comprising:
displaying the information by the computer; and
recording operator verification of the information by the computer prior to sending.

3. The method of claim 1, wherein the computer comprises a mobile communication device and the image capture device is in the mobile communication device.

4. The method of claim 1, wherein the computer comprises a personal computer and the image capture device is connected to the personal computer.

5. The method of claim 1, wherein the computer comprises a kiosk and the image capture device is connected to the kiosk.

6. The method of claim 1, wherein the identification document comprises a passport.

7. The method of claim 1, wherein the website comprises a travel check-in website.

8. The method of claim 1, wherein sending further comprises sending the image to the website.

9. A processor-implemented method programmed in a non-transitory processor-readable medium and to execute on one or more processors of a computer configured to execute the method, comprising:
connecting to a travel check-in website by the computer;
operating an image capture device by the computer to capture an image of an identification document of a passenger checking in;
obtaining machine readable information from the image by the computer; and
sending the machine readable information and the image to the travel check-in website by the computer.

10. The method of claim 9, further comprising:
displaying the machine readable information; and
recording operator verification of the machine readable information prior to sending.

11. The method of claim 9, wherein the identification document comprises a passport.

12. The method of claim 9, wherein the identification document comprises a visa.

13. The method of claim 9, wherein the computer comprises a mobile communication device and the image capture device is in the mobile communication device.

14. The method of claim 9, wherein the computer comprises a personal computer and the image capture device is connected to the personal computer.

15. The method of claim 9, wherein the computer comprises a kiosk and the image capture device is connected to the kiosk.

16. A processor-implemented method programmed in a non-transitory processor-readable medium and to execute on one or more processors of a server configured to execute the method, comprising:
hosting a travel check-in website;
prompting a passenger to operate an image capture device to capture an image of an identification document of the passenger during check-in at the travel check-in website;
receiving machine readable information from the image; and
storing the machine readable information in a passenger record.

17. The method of claim 16, wherein receiving further comprises receiving the image.

18. The method of claim 16, further comprising providing an indication to an agent that the passenger has sent the machine readable information to the travel check-in website in lieu of providing the identification document to the agent.

19. The method of claim 16, further comprising:
receiving identifying information from the passenger; and
verifying the identifying information before prompting.
